(19) United States
(12) Patent Application Publication
(10) Pub. No.: US 2020/0055275 A1
(43) Pub. Date: Feb. 20, 2020

(54) FOAM CONSTRUCTION BOARDS WITH ENHANCED FIRE PERFORMANCE

(71) Applicant: Firestone Building Products Company, LLC, Nashville, TN (US)

(72) Inventors: Chunhua Yao, Carmel, IN (US); Michael J. Hubbard, Murfreesboro, TN (US); John B. Letts, Carmel, IN (US)

(21) Appl. No.: 16/609,977

(22) PCT Filed: May 7, 2018
(86) PCT No.: PCT/US18/31360

§ 371 Date: Oct. 31, 2019

Related U.S. Application Data
(60) Provisional application No. 62/501,819, filed on May 5, 2017.

(51) Int. Cl. B32B 5/18; B32B 29/00; B32B 5/02; B32B 5/24; E04B 1/94; E04C 2/20; E04C 2/24

(52) U.S. Cl. CPC B32B 5/18; B32B 29/007; B32B 5/022; B32B 5/245; E04B 1/942; E04C 2/205; B32B 2419/06; B32B 2266/0278; B32B 2307/3065; B32B 2255/02; B32B 2255/12; B32B 2262/101; B32B 2255/26; E04C 2/24

(57) ABSTRACT

A construction board comprising (i) a foam layer; (ii) a facer substrate; and (iii) a fire-resistant interfacial layer disposed between said facer substrate and said foam layer.

This application claims the benefit of U.S. Provisional Application Ser. No. 62/501,819 filed on May 5, 2017, which is incorporated herein by reference.

### FIELD OF THE INVENTION

Embodiments of the present invention are directed toward foam construction boards that include particulate fire-resistant material sandwiched between the foam body and the facer of the construction board.

### BACKGROUND OF THE INVENTION

Construction boards, particularly those employed in the construction industry, may include a foam layer and at least one facer. Often, the foam layer is sandwiched between two facers. The foam layer can include a closed cell polyurethane or polyisocyanurate foam.

The facer materials can impact the ultimate performance of the construction boards. This is particularly true where the construction boards include roofing insulation boards or roofing recover boards that must meet various performance specifications.

Numerous facer materials have been employed; for example, the art teaches cellulosic, foil, and fiberglass facers.

### SUMMARY OF THE INVENTION

Embodiments of the present invention provide a construction board comprising (i) a foam layer; (ii) a facer substrate; and (iii) a fire-resistant interfacial layer disposed between said facer substrate and said foam layer.

Other embodiments of the present invention provide a construction board comprising (i) polyurethane or polyisocyanurate foam body having first and second planar surfaces; (ii) a facer positioned adjacent to said first planar surface of said foam body; and (iii) a fire-resistant interfacial layer disposed between said facer and first planar surface, where said fire-resistant interfacial layer includes an intumescent material.

### BRIEF DESCRIPTION OF THE DRAWINGS

FIG. 1 is a perspective view of a construction board of one or more embodiments of the present invention.

FIG. 2 is a cross sectional side view of a construction board according to one or more embodiments of the present invention.

FIG. 3 is a perspective view of a roofing system including one or more construction boards according to practice of one or more embodiments of the present invention.

### DETAILED DESCRIPTION OF ILLUSTRATIVE EMBODIMENTS

Embodiments of the present invention are based, at least in part, on the discovery of a foamed construction board composite including intumescent fire-resistant materials positioned at or near the interface between a foam body and a facer of the composite. In particular embodiments, the fire-resistant materials include expandable graphite. It has unexpectedly been discovered that by positioning the fire-resistant materials between the facer and the foam body, the fire-resistant materials are held in place during a fire event, which thereby inhibits penetration of flame into the foam layer. Where the fire-resistant materials are secured to the outer surfaces of the composite, such as the outer surface of the facer, it has been observed that the fire-resistant materials can be dislodged during a fire event, thereby allowing flame to penetrate into the foam layer.

### Construction Board Configuration

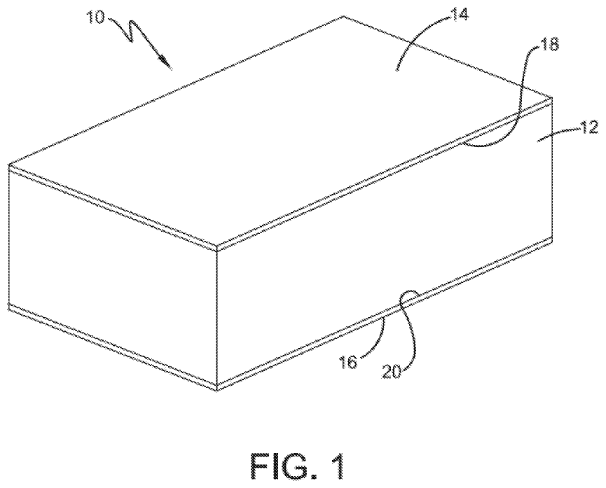

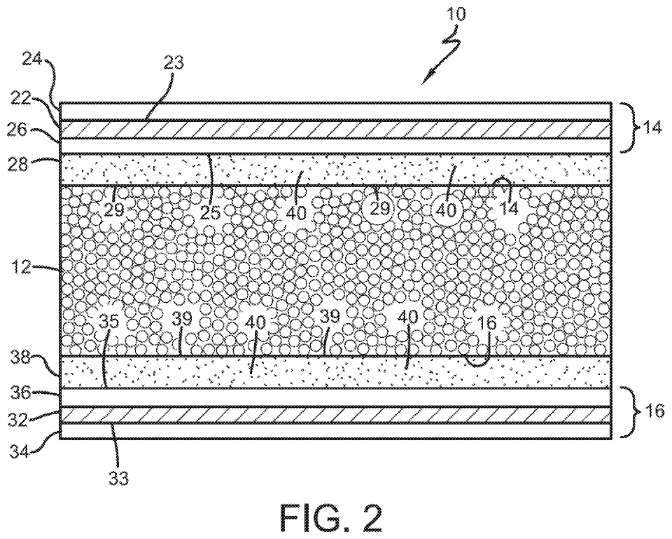

Construction boards of one or more embodiments of the present invention may be generally described with reference to FIGS. 1 and 2. FIG. 1 shows a construction board that is indicated generally by the numeral 10. Construction board 10 includes a foam layer 12, which may be referred to as foam core 12, sandwiched between first facer 14 and optional second facer 16. Facers 14 and 16 are attached to foam layer 12 at first planar surface 18 and second planar surface 20, respectively, of foam layer 12. In one or more embodiments, facer 14 (and optionally facer 16) are continuous over the entire planar surface 18 (or planar surface 20) of foam core 12. In these or other embodiments, facer 14 (and optionally facer 16) is discontinuous; for example, the facers may be perforated so as to allow fluid or gaseous communication between the foam and the environment. In one or more embodiments, the foam construction boards of this invention include opposed coated facers 14 and 16.

As shown in FIG. 2, first facer 14 of one or more embodiments may include a fabric 22, which may also be referred to as substrate 22, an optional coating layer 24, which may also be referred to as external coating 24, and an optional coating layer 26, which may also be referred to as internal coating 26. Likewise, second facer 16 of one or more embodiments includes a fabric 32, which may also be referred to as substrate 32, an optional coating layer 34, which may also be referred to as external coating 34, and an optional coating layer 36, which may also be referred to as internal coating 36. As indicated by the figures, coatings 24 and 34 may be situated on or disposed on planar surfaces 23 and 33 of substrates 22 and 32 respectively, which surfaces are opposite foam layer 12 relative to substrates 22 and 32, respectively.

As also shown in FIG. 2, a particulate fire-resistant material 40 is disposed between foam body 12 and first facer 14. Stated another way, fire-resistant material 40 is positioned at the interface between first facer 14 and foam body 12. Likewise, in one or more embodiments, fire-resistant material 40 is disposed between foam body 12 and second facer 16. Stated another way, fire-resistant material 40 is positioned at the interface between second facer 16 and foam body 12.

In one or more embodiments, fire-resistant material 40 is dispersed throughout a layer 28, which may be referred to as fire-resistant interfacial layer or region 28, which layer is positioned between first facer 14 and foam body 12. Similarly, fire-resistant material 40 may be dispersed throughout a layer 38, which may be referred to as fire-resistant interfacial layer or region 38, which layer is positioned between second facer 16 and foam body 12. Layer 28, as well as layer 38, may include a matrix material 29, 39 which may also be referred to as binder 29, 39. As shown, fire-resistant material 40 may be dispersed throughout binder 29, 39 within layers 28, 38.

### Foam Core

In one or more embodiments, foam layer 12 includes a rigid closed-cell foam structure. In one or more embodiments, foam layer 12 may include a polyurethane or polyisocyanurate foam. As the skilled person appreciates, the closed-cell foam includes a plurality of cells and an interconnected network of solid struts or plates that form the edges and faces of the cells. The solid portion (i.e. the interconnected network) is formed from the foam-forming material (e.g. the polyurethane or polyisocyanurate). The solid portion of foam layer 12 (i.e. the matrix) may include other constituents as is generally known in the art. As will be discussed in greater detail below, additional flame or fire resistant materials can be dispersed within the solid portion of foam layer 12. Additionally, in one or more embodiments, the expandable graphite can be dispersed within the solid portion of foam layer 12 in combination with a non-halogenated flame retardant.

In one or more embodiments, foam layer 12 may be characterized by a foam density (ASTM C303) that is less than 2.5 pounds per cubic foot (12 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, the foam layer 12 of insulation boards is characterized by having a density that is greater than 1.50 pounds per cubic foot (7.32 kg/m²), or in other embodiments, greater than 1.55 pounds per cubic foot (7.57 kg/m²).

Where the density of foam layer 12 is less than 2.5 pounds per cubic foot, it may be advantageous for foam layer 12 to be characterized by having an index of at least 120, in other embodiments at least 150, in other embodiments at least 175, in other embodiments at least 200, and in other embodiments at least 225, as determined by PIR/PUR ratio as determined by IR spectroscopy using standard foams of known index (note that ratio of 3 PIR/PUR provides an ISO Index of 300). Foam construction boards having a foam layer of similar nature are described in U.S. Pat. Nos. 6,117,375, 6,044,604, 5,891,563, 5,573,092, U.S. Publication Nos. 2004/0109983, 2003/0082365, 2003/0153656, 2003/0032351, and 2002/0013379, as well as U.S. Ser. Nos. 10/640,895, 10/925,654, and 10/632,343, which are incorporated herein by reference.

In other embodiments, foam layer 12 may be characterized by density that is greater than 2.5 pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density of foam layer 12 of the recovery boards may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²). Foam construction boards having a foam layer of similar nature are described in U.S. application Ser. Nos. 11/343,466 and 12/525,159, which are incorporated herein by reference.

Where the density of foam layer 12 is greater than 2.5 pounds per cubic foot, it may be advantageous for foam layer 12 to be characterized by an ISO Index, as determined by PIR/PUR ratio as determined by IR spectroscopy using standard foams of known index (note that ratio of 3 PIR/PUR provides an ISO Index of 300) of at least 180, in other embodiments at least 200, in other embodiments at least 220, in other embodiments at least 270, in other embodiments at least 285, in other embodiments at least 300, in other embodiments at least 315, and in other embodiments at least 325. In these or other embodiments, the ISO Index may be less than 360, in other embodiments less than 350, in other embodiments less than 340, and in other embodiments less than 335.

In one or more embodiments, the thickness of foam layer 12 may be greater than 0.5 cm, in other embodiments greater than 1, and in other embodiments greater than 2 cms. In these or more embodiments, the thickness of foam layer 12 may be less than 15 cm, in other embodiments less than 12, and in other embodiments less than 8 cms. In one or more embodiments, the thickness of foam layer 12 may be from about 0.5 to about 15 cms, in other embodiments from about 1 to about 12 cms, and in other embodiments from about 2 to about 8 cms.

### Fire-Resistant Interfacial Layer

As suggested above, fire-resistant interfacial layer 28 (as well as layer 38) may include fire-resistant material or particulate dispersed throughout a binder or matrix. In one or more embodiments, the fire-resistant material or particulate is expandable graphite.

In one or more embodiments, the thickness of fire-resistant interfacial layer 28 (as well as layer 38) may be greater than 1 μm, in other embodiments greater than 20 μm, and in other embodiments greater than 50 μm. In these or other embodiments, the thickness or fire-resistant interfacial layer 28 (as well as layer 38) may be less than 5 mm, in other embodiments less than 1 mm, and in other embodiments less than 0.5 mm. In one or more embodiments, the thickness of fire-resistant interfacial layer 28 (as well as layer 38) may be from about 1 μm to about 5 mm, in other embodiments from about 20 μm to about 1 mm, and in other embodiments from about 50 μm to about 0.5 mm.

In one or more embodiments, the concentration of the fire-resistant material (e.g. expandable graphite) within fire-resistant interfacial layer 28 (as well as layer 38) may be expressed as the weight of fire-resistant filler relative to the entire weight of the layer. In one or more embodiments, the amount of fire-resistant filler within the interfacial layers may be more than 0.5 wt. %, in other embodiments more than 1.0 wt. %, and in other embodiments more than 3.0 wt. %. In these or more embodiments, the amount of fire-resistant filler within the interfacial layers may be less than 50 wt. %, in other embodiments less than 40 wt. %, and in other embodiments less than 30 wt. %. In one or more embodiments, the amount of fire-resistant filler within the interfacial layers may be from about 0.5 to about 50 wt. %, in other embodiments from about 1.0 to about 40 wt. %, and in other embodiments from about 3.0 to about 30 wt. %.

### Binder

In one or more embodiments, the binder (e.g. binder 29, 39) may include natural or synthetic materials. For example, natural materials may include natural rubber, waxes and starches. Synthetic materials may include polyolefins, styrene-butadiene latexes, polyvinyl chlorides, acrylic latexes, and methacrylic latexes, silicones, as well as functional copolymers thereof. For example, the binders may include styrene-butadiene latexes bearing one or more hydrophobic moieties (e.g. fluorine-containing groups) for repelling water. Still other examples include, but not limited to, polyurethane coating compositions, polymeric resin coating compositions, and siloxane coating compositions, as well as polymer-modified asphalt or bitumen coating compositions.

### Fire-Resistant Materials

As suggested above, the construction boards of the present invention include a fire-resistant material 40, which may be an intumescent material, sandwiched between the facer substrate and the foam body of the construction boards. These fire-resistant materials, which may also be referred to as fire-resistant fillers, may include natural or synthetic materials.

In other embodiments, the fire-resistant materials include intumescent materials such as expandable graphite. In specific embodiments, the fire-resistant materials include expandable graphite inasmuch as unexpected results have been discovered when expandable graphite is employed as the fire-resistant material in accordance with the present invention.

In one or more embodiments, expandable graphite, which may also be referred to as expandable flake graphite, intumescent flake graphite, or expandable flake, includes intercalated graphite in which an intercallant material is included between the graphite layers of graphite crystal or particle. Examples of intercallant materials include halogens, alkali metals, sulfates, nitrates, various organic acids, aluminum chlorides, ferric chlorides, other metal halides, arsenic sulfides, and thallium sulfides. In certain embodiments of the present invention, the expandable graphite includes non-halogenated intercallant materials. In certain embodiments, the expandable graphite includes sulfate intercallants, also referred to as graphite bisulfate. As is known in the art, bisulfate intercalation is achieved by treating highly crystalline natural flake graphite with a mixture of sulfuric acid and other oxidizing agents which act to catalyze the sulfate intercalation.

Commercially available examples of expandable graphite include HPMS Expandable Graphite (HP Materials Solutions, Inc., Woodland Hills, Calif.) and Expandable Graphite Grades 1721 (Asbury Carbons, Asbury, N.J.). Other commercial grades contemplated as useful in the present invention include 1722, 3393, 3577, 3626, and 1722HT (Asbury Carbons, Asbury, N.J.).

In one or more embodiments, the expandable graphite may be characterized as having a mean or average size in the range from about 30 μm to about 1.5 mm, in other embodiments from about 50 μm to about 1.0 mm, and in other embodiments from about 180 to about 850 μm. In certain embodiments, the expandable graphite may be characterized as having a mean or average size of at least 30 μm, in other embodiments at least 44 μm, in other embodiments at least 180 μm, and in other embodiments at least 300 μm. In one or more embodiments, expandable graphite may be characterized as having a mean or average size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments, the expandable graphite may be characterized as having a nominal particle size of 20×50 (US sieve). US sieve 20 has an opening equivalent to 0.841 mm and US sieve 50 has an opening equivalent to 0.297 mm. Therefore, a nominal particle size of 20×50 indicates the graphite particles are at least 0.297 mm and at most 0.841 mm.

In one or more embodiments, the expandable graphite may be characterized as having a carbon content in the range from about 75% to about 99%. In certain embodiments, the expandable graphite may be characterized as having a carbon content of at least 80%, in other embodiments at least 85%, in other embodiments at least 90%, in yet other embodiments at least 95%, in other embodiments at least 98%, and in still other embodiments at least 99% carbon.

In one or more embodiments, the expandable graphite may be characterized as having a sulfur content in the range from about 0% to about 8%, in other embodiments from about 2.6% to about 5.0%, and in other embodiments from about 3.0% to about 3.5%. In certain embodiments, the expandable graphite may be characterized as having a sulfur content of at least 0%, in other embodiments at least 2.6%, in other embodiments at least 2.9%, in other embodiments at least 3.2%, and in other embodiments 3.5%. In certain embodiments, the expandable graphite may be characterized as having a sulfur content of at most 8%, in other embodiments at most 5%, in other embodiments at most 3.5%.

In one or more embodiments, the expandable graphite may be characterized as having an expansion ratio (cc/g) in the range from about 10:1 to about 500:1, in other embodiments at least 20:1 to about 450:1, in other embodiments at least 30:1 to about 400:1, in other embodiments from about 50:1 to about 350:1. In certain embodiments, the expandable graphite may be characterized as having an expansion ratio (cc/g) of at least 10:1, in other embodiments at least 20:1, in other embodiments at least 30:1, in other embodiments at least 40:1, in other embodiments at least 50:1, in other embodiments at least 60:1, in other embodiments at least 90:1, in other embodiments at least 160:1, in other embodiments at least 210:1, in other embodiments at least 220:1, in other embodiments at least 230:1, in other embodiments at least 270:1, in other embodiments at least 290:1, and in yet other embodiments at least 300:1. In certain embodiments, the expandable graphite may be characterized as having an expansion ratio (cc/g) of at most 350:1, and in yet other embodiments at most 300:1.

In one or more embodiments, the expandable graphite may be characterized as having a pH in the range from about 1 to about 12; in other embodiments from about 1 to about 6; and in yet other embodiments from about 5 to about 10. In certain embodiments, the expandable graphite may be characterized as having a pH in the range from about 4 to about 7. In one or more embodiments, the expandable graphite may be characterized as having a pH of at least 1, in other embodiments at least 4, and in other embodiments at least 5. In certain embodiments, the expandable graphite may be characterized as having a pH of at most 10, in other embodiments at most 7, and in other embodiments at most 6.

In one or more embodiments, the expandable graphite may be characterized by an onset temperature ranging from about 100° C. to about 250° C.; in other embodiments from about 160° C. to about 225° C.; and in other embodiments from about 180° C. to about 200° C. In one or more embodiments, the expandable graphite may be characterized by an onset temperature of at least 100° C., in other embodiments at least 130° C., in other embodiments at least 160° C., and in other embodiments at least 180° C. In one or more embodiments, the expandable graphite may be characterized by an onset temperature of at most 250° C., in other embodiments at most 225° C., and in other embodiments at most 200° C. Onset temperature may also be interchangeably referred to as expansion temperature; and may also be referred to as the temperature at which expansion of the graphite starts.

### Facers

As suggested above, and with reference again to FIG. 2, facer 14, as well as optional facer 16, includes a substrate 22 (or substrate 32) and an optional coating 24 (or optional coating 34), which may also be referred to as external coating 24 (or external coating 34), disposed on the substrate. It should be appreciated that reference to facer 14 or facer 16 is made for ease of description in view of the fact that facers used in the manufacture of construction boards typically include a coated substrate. The skilled person will appreciate that reference to facer may include simply the substrate or, in other embodiments, may include other constituents such as multiple coating layers. Specifically, and as will be discussed in further detail below, reference to facer may include the fire-resistant interfacial layer of this invention, which layer may be incorporated into or onto the facer prior to foam production.

### Inorganic Substrate

In one or more embodiments, substrate 22, as well as substrate 32, is an inorganic substrate. In particular embodiments, the substrate is a non-woven inorganic mat, and therefore reference may be made to glass substrate 22 (or 32). Exemplary types of non-woven mat include fiberglass mats, which may also be referred to as glass mats. In one or more embodiments, the non-woven fiberglass mats include glass fibers and a binder that binds the glass fibers together and maintains the fibers in a mat form. Any type of glass fiber mat can be used in the composite board. For example, a non-woven glass fiber mat can be made with glass fibers, the fibers can be bonded with an aqueous thermosetting resin such as, for example, urea formaldehyde or phenolic resole resins. As the skilled person will appreciate, these binder resins are conventional in the art of non-woven glass mats, and the skilled person will understand that the coating, as taught herein, is distinct, in both composition and structure, from this binder.

In one or more embodiments, the dimensional and weight characteristics of glass substrate 22 (or 32) are not particularly limited, and can depend on the specific application and desired properties of the coverboard. For example, the basis weight of glass substrate 22 (or 32) can be from about 50 grams per square meter to about 150 grams per square meter. The thickness of glass substrate 22 (or 32) can be, for example, from about 0.015 inch to about 0.05 inch (about 0.038 to about 0.13 cm). The basis weight and thickness characteristics can be adjusted depending upon the desired rigidity, strength and weight of the composite board.

In one or more embodiments, the thickness of glass substrate 22 (or 32) (absent the coating layer described herein) may be from about 0.01 to about 1.00 inch (about 0.03 to about 2.54 cm) or in other embodiments from about 0.015 to about 0.05 inches thick (about 0.038 to about 0.13 cm).

### Facer Coating

In one or more embodiments, optional coating 24, 26 (as well as optional coating 34, 36) includes a binder or matrix and optionally filler or other constituents dispersed throughout the binder. In one or more embodiments, the external coating includes an inorganic filler or mineral dispersed throughout a binder. In one or more embodiments, the external coating is devoid or substantially devoid of expandable graphite.

In one or more embodiments, optional coating 24, 26 (as well as optional coating 34, 36) may have a thickness of at least 0.005 mm, in other embodiments at least 0.01 mm, in other embodiments 0.05 mm, and in other embodiments at least 0.09 mm. In these or other embodiments, coating 24 may have a thickness of less than 1.5 mm, in other embodiments less than 1.0 mm, in other embodiments less than 0.7 mm, in other embodiments less than 0.3 mm, and in other embodiments less than 0.1 mm.

In one or more embodiments, the concentration of filler within optional coating 24, 26 (as well as optional coating 34, 36) may be expressed as the weight of filler relative to the entire weight of the layer. In one or more embodiments, the amount of filler within the external layers may be more than 0.5 wt. %, in other embodiments more than 1.0 wt. %, and in other embodiments more than 3.0 wt. %. In these or more embodiments, the amount of filler within the external layers may be less than 50 wt. %, in other embodiments less than 40 wt. %, and in other embodiments less than 30 wt. %. In one or more embodiments, the amount of filler within the external layers may be from about 0.5 to about 50 wt. %, in other embodiments from about 1.0 to about 40 wt. %, and in other embodiments from about 3.0 to about 30 wt. %.

### Fillers for Facer Coatings

As indicated above, layer 24 and/or 26, as well as layer 34 and/or 36, may include a filler dispersed within a matrix binder. In one or more embodiments, the filler may include a mineral filler. Mineral fillers may include clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof.

Suitable clays may include airfloated clays, water-washed clays, calcined clays, surface-treated clays, chemically-modified clays, and mixtures thereof.

Suitable silicates may include synthetic amorphous calcium silicates, precipitated, amorphous sodium aluminosilicates, and mixtures thereof.

Suitable silica (silicon dioxide) may include wet-processed, hydrated silicas, crystalline silicas, and amorphous silicas (noncrystalline).

In one or more embodiments, the fillers are not surface modified or surface functionalized.

In one or more embodiments, the mineral fillers are characterized by an average particle size of at least 1 μm, in other embodiments at least 2 μm, in other embodiments at least 3 μm, in other embodiments at least 4 μm, and in other embodiments at least 5 μm. In these or other embodiments, the mineral fillers are characterized by an average particle size of less than 15 μm, in other embodiments less than 12 μm, in other embodiments less than 10 μm, and in other embodiments less than 8 μm. In these or other embodiments, the mineral filler has an average particle size of between 1 and 15 μm, in other embodiments between 3 and 12 μm, and in other embodiments between 6 and 10 μm.

### Preparation of Construction Boards

Generally speaking, the construction boards of the present invention can be prepared by using known techniques that are adapted in view of the teachings of this invention. In general, processes for the manufacture of polyurethane or polyisocyanurate insulation boards are known in the art as described in U.S. Pat. Nos. 6,117,375, 6,044,604, 5,891,563, 5,573,092, U.S. Publication Nos. 2004/0109983, 2003/0082365, 2003/0153656, 2003/0032351, and 2002/0013379, as well as U.S. Ser. Nos. 10/640,895, 10/925,654, and 10/632,343, which are incorporated herein by reference.

As the skilled person appreciates, foam may be produced by developing or forming polyurethane and/or polyisocyanurate foam in the presence of a blowing agent. The foam may be prepared by contacting an A-side stream of reagents with a B-side stream of reagents and depositing the mixture or developing foam onto a laminator carrying a facer, which may include one or more of the coating and/or fire-resistant layers described herein. The A-side stream may include an isocyanate compound and the B-side may include an isocyanate-reactive compound.

In one or more embodiments, optional coating 24, 26 (as well as optional coating 34, 36) may be applied to substrate 22 (or 32) prior to foam-forming operation by applying a liquid coating composition by employing conventional coating techniques. For example, coating 24 may be applied by gravure coating, reverse roll coating, slot die coating, immersion (dip) coating, knife coating, electrohydrodynamic spraying, and the like. In one or more embodiments, these liquid coating compositions may include at least 0.5 wt. %, in other embodiments at least 1.0 wt. %, in other embodiments at least 3 wt. %, in other embodiments at least 5 wt. %, and in other embodiments at least 7 wt. % filler, based on the entire weight of the liquid composition. In these or other embodiments, these coating compositions include at most 40 wt. %, in other embodiments at most 30 wt. %, in other embodiments at most 25 wt. %, in other embodiments at most 20 wt. %, and in other embodiments at most 15 wt. % filler, based on the entire weight of the liquid composition. In one or more embodiments, these compositions include from about 0.5 to about 40, in other embodiments from about 1 to about 25, and in other embodiments from about 2 to about 20 wt. % filler, based upon the entire weight of the liquid composition.

Similarly, a coating, which forms fire-resistant interfacial layer 28 or 38, can be applied to respective substrates 22, 32 (or to optional coating layers 26, 36) in the form of a liquid coating composition that includes fire-resistant materials such as expandable graphite. As the skilled person will appreciate, this coating, including the fire-resistant material such as expandable graphite, is applied to a planar surface of the facer 14, 16 that will be mated to foam 12. The coating composition forming fire-resistant layer 28, 38 may be applied by gravure coating, reverse roll coating, slot die coating, immersion (dip) coating, knife coating, electrohydrodynamic spraying, and the like. In one or more embodiments, these liquid coating compositions (i.e. those forming layers 28 and 38) may include at least 0.5 wt. %, in other embodiments at least 1.0 wt. %, in other embodiments at least 3 wt. %, in other embodiments at least 5 wt. %, and in other embodiments at least 7 wt. % fire-resistant material (e.g., expandable graphite), based on the entire weight of the liquid composition. In these or other embodiments, these coating compositions include at most 40 wt. %, in other embodiments at most 30 wt. %, in other embodiments at most 25 wt. %, in other embodiments at most 20 wt. %, and in other embodiments at most 15 wt. % fire-resistant material (e.g., expandable graphite), based on the entire weight of the liquid composition. In one or more embodiments, these liquid coating compositions include from about 0.5 to about 40, in other embodiments from about 1 to about 25, and in other embodiments from about 2 to about 20 wt. % fire-resistant material (e.g., expandable graphite), based upon the entire weight of the liquid composition.

In other embodiments, layers 28, 38 may be applied directly to foam 12, and then facer 14, 16 is subsequently mated to layer 28, 38. This can be accomplished as part of the foam-forming operation prior to application of the facer and prior to lamination of the board.

### A-Side Stream

As suggested above, the A-side stream includes an isocyanate. Suitable isocyanate-containing compounds useful for the manufacture of polyisocyanurate construction board are generally known in the art and embodiments of this invention are not limited by the selection of any particular isocyanate-containing compound. Useful isocyanate-containing compounds include polyisocyanates. Useful polyisocyanates include aromatic polyisocyanates such as diphenyl methane diisocyanate in the form of its 2,4′-, 2,2′-, and 4,4′-isomers and mixtures thereof. The mixtures of diphenyl methane diisocyanates (MDI) and oligomers thereof may be referred to as “crude” or polymeric MDI, and these polyisocyanates may have an isocyanate functionality of greater than 2. Other examples include toluene diisocyanate in the form of its 2,4′ and 2,6′-isomers and mixtures thereof, 1,5-naphthalene diisocyanate, and 1,4′ diisocyanatobenzene. Exemplary polyisocyanate compounds include polymeric Rubinate 1850 (Huntsmen Polyurethanes), polymeric Lupranate M70R (BASF), and polymeric Mondur 489N (Bayer).

### B-Side Stream

As suggested above, the B-side stream includes an isocyanate-reactive compound, and may also include flame retardants, catalysts, emulsifiers/solubilizers, surfactants, blowing agents, fillers, fungicides, anti-static substances, water and other ingredients that are conventional in the art.

An exemplary isocyanate-reactive component is a polyol. The term polyol, or polyol compound, includes diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Invista), and a blended polyol TR 564 (Huntsman). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one or more embodiments, a polyester polyol is employed. In one or more embodiments, the present invention may be practiced in the appreciable absence of any polyether polyol. In certain embodiments, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris [(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

Surfactants may serve two purposes. First, they may help to emulsify/solubilize all the components so that they react completely. Second, they may promote cell nucleation and cell stabilization. Exemplary surfactants include silicone copolymers or organic polymers bonded to a silicone polymer. Although surfactants can serve both functions, a more cost effective method to ensure emulsification/solubilization may be to use enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant 58522, and GE 6912. U.S. Pat. Nos. 5,686,499 and 5,837,742 are incorporated herein by reference to show various useful surfactants.

Suitable emulsifiers/solubilizers include DABCO Ketene 20AS (Air Products), and Tergitol NP-9 (nonylphenol+9 moles ethylene oxide).

Useful blowing agents include isopentane, n-pentane, cyclopentane, alkanes, (cyclo)alkanes, hydrofluorocarbons, hydrochlorofluorocarbons, fluorocarbons, fluorinated ethers, alkenes, alkynes, carbon dioxide, hydrofluoroolefins (HFOs) and noble gases.

Flame Retardants may be used in the production of polyurethane and polyisocyanurate foams, especially when the foams contain flammable blowing agents such as pentane isomers. Useful flame retardants include tri(monochloropropyl) phosphate (a.k.a. tris(cloro-propyl) phosphate), tri-2-chloroethyl phosphate (a.k.a tris(chloro-ethyl) phosphate), phosphonic acid, methyl ester, dimethyl ester, and diethyl ester. U.S. Pat. No. 5,182,309 is incorporated herein by reference to show useful blowing agents.

Exemplary non-halogenated solid flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), melamine polyphosphate is available under the tradename Budit™ 3141 (Budenheim), and antimony oxide (Sb₂O₃) is commercially available under the tradename Fireshield™. Exemplary non-halogenated liquid flame retardants include triethylphosphate, such as that available under the tradename TEP (Lanxess). Exemplary reactive flame retardants include liquid reactive phosphates such as those available under the tradenames E06-16 (ICL) FYROL (ICL).

### Foam Production

The respective streams can be mixed within, for example, a mixhead to produce a reaction mixture. The mixture can then be deposited onto a facer that is positioned within and carried by a laminator. In accordance with the present invention, the mixture can be deposited onto a facer having a fire-resistant coating layer disposed thereon (i.e. layer 28 or 38). Specifically, the foam mixture is deposited directly onto the fire-resistant coating layer. While in laminator, the reaction mixture rises and can be married to a second facer to form a composite, which may also be referred to as a laminate, wherein the foam is sandwiched between upper and lower facers. Likewise, in accordance with this invention, the second facer may carry a fire-resistant coating layer (i.e. layer 28 or 38), and this fire-resistant coating layer is placed into contact with the rising foam.

The composite, while in laminator, or after removal from laminator, is exposed to heat that may be supplied by, for example, oven. For example, laminator may include an oven or hot air source that heats the slats and side plates of the laminator and there through transfers heat to the laminate (i.e. to the reaction mixture). Once subjected to this heat, the foam composite can undergo conventional finishing within a finishing station, which may include, but is not limited to, trimming and cutting.

According to practice of this invention, the foam mixture is deposited onto a facer that includes a coating layer that includes expandable graphite and optionally non-halogenated flame retardant. As indicated above, the coating (including expandable graphite) is applied to one planar surface of a facer substrate, and the foam mixture is deposited onto the opposite planar surface of the facer substrate (i.e. the surface that does not include expandable graphite). Likewise, the second facer that is married to the rising foam can likewise include a coating including expandable graphite and optionally non-halogenated flame retardant, and the second facer is married to the rising foam opposite the coating.

### INDUSTRIAL APPLICABILITY

In one or more embodiments, the construction boards of this invention may be employed in roofing or wall applications. In particular embodiments, the construction boards are used in flat or low-slope roofing system.

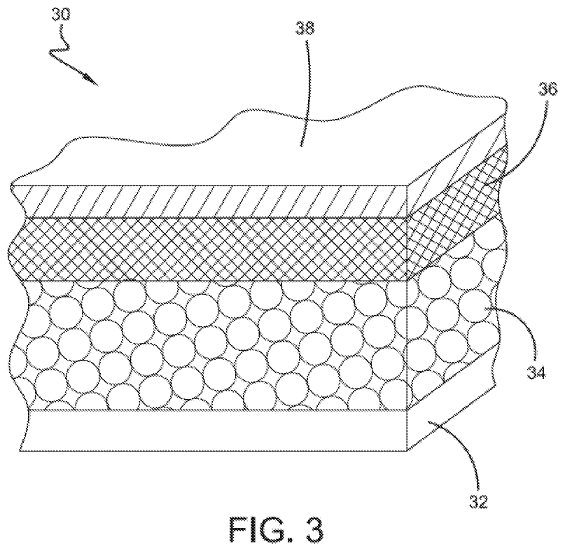

As shown in FIG. 3, roofing system 30 includes a roof deck 32 having insulation board 34, which may be fabricated according to practice of this invention, disposed thereon. An optional high density board 36, which may also be fabricated according to practice of this invention, positioned above, relative to the roof deck, insulation board 34. A water-protective layer or membrane 38 is disposed on top or above high density board 36. In alternate embodiments, not shown, optional high density board 36 may be below insulation board 34 relative to the roof deck.

Practice of this invention is not limited by the selection of any particular roof deck. Accordingly, the roofing systems of this invention can include a variety of roof decks. Exemplary roof decks include concrete pads, steel decks, wood beams, and foamed concrete decks.

Practice of this invention is likewise not limited by the selection of any water-protective layer or membrane. As is known in the art, several membranes can be employed to protect the roofing system from environmental exposure, particularly environmental moisture in the form of rain or snow. Useful protective membranes include polymeric membranes. Useful polymeric membranes include both thermoplastic and thermoset materials. For example, and as is known in the art, membrane prepared from poly(ethylene-co-propylene-co-diene) terpolymer rubber or poly(ethylene-co-propylene) copolymer rubber can be used. Roofing membranes made from these materials are well known in the art as described in U.S. Pat. Nos. 6,632,509, 6,615,892, 5,700,538, 5,703,154, 5,804,661, 5,854,327, 5,093,206, and 5,468,550, which are incorporated herein by reference. Other useful polymeric membranes include those made from various thermoplastic polymers or polymer composites. For example, thermoplastic olefin (i.e. TPO), thermoplastic vulcanizate (i.e. TPV), or polyvinylchloride (PVC) materials can be used. The use of these materials for roofing membranes is known in the art as described in U.S. Pat. Nos. 6,502,360, 6,743,864, 6,543,199, 5,725,711, 5,516,829, 5,512,118, and 5,486,249, which are incorporated herein by reference. In one or more embodiments, the membranes include those defined by ASTM D4637-03 and/or ASTM D6878-03.

Still in other embodiments, the protective membrane can include bituminous or asphalt membranes. In one embodiment, these asphalt membranes derive from asphalt sheeting that is applied to the roof. These asphalt roofing membranes are known in the art as described in U.S. Pat. Nos. 6,579,921, 6,110,846, and 6,764,733, which are incorporated herein by reference. In other embodiments, the protective membrane can derive from the application of hot asphalt to the roof.

Other layers or elements of the roofing systems are not excluded by the practice of this invention. For example, and as is known in the art, another layer of material can be applied on top of the protective membrane. Often these materials are applied to protect the protective membranes from exposure to electromagnetic radiation, particularly that radiation in the form of UV light. In certain instances, ballast material is applied over the protective membrane. In many instances, this ballast material simply includes aggregate in the form of rock, stone, or gravel; U.S. Pat. No. 6,487,830, is incorporated herein in this regard.

The construction boards of this invention can be secured to a building structure by using various known techniques. For example, in one or more embodiments, the construction boards can be mechanically fastened to the building structure (e.g. the roof deck). In other embodiments, the construction boards can be adhesively secured to the building structure.

Various modifications and alterations that do not depart from the scope and spirit of this invention will become apparent to those skilled in the art. This invention is not to be duly limited to the illustrative embodiments set forth herein.

1. A construction board comprising:
(i) a foam layer;
(ii) a facer substrate; and
(iii) a fire-resistant interfacial layer disposed between said facer substrate and said foam layer.

2. The construction board of claim 1, wherein the foam layer is polyisocyanurate or polyurethane foam.

3. The construction board of claim 1, where the fire-resistant interfacial layer includes a binder and fire-resistant material dispersed within said binder.

4. The construction board of claim 1, where the fire-resistant material is expandable graphite.

5. The construction board of claim 1, wherein the facer substrate is a glass mat.

6. The construction board of claim 1, wherein the facer substrate is cellulosic.

7. The construction board of claim 1, wherein the construction board includes an external coating disposed on said facer substrate opposite said fire-resistant interfacial layer.

8. The construction board of claim 1, where the construction board includes first and second facer substrates, said first substrate being adjacent to a first planar surface of the foam layer and said second substrate being adjacent to a second planar surface of the foam layer.

9. The construction board of claim 1, where said external coating includes a mineral filler dispersed within a binder matrix.

10. The construction board of claim 1, where said fire-resistant interfacial layers includes from about 0.5 to about 50 wt. % filler relative to the entire weight of the layer.

11. A construction board comprising:
(i) polyurethane or polyisocyanurate foam body having first and second planar surfaces;
(ii) a facer positioned adjacent to said first planar surface of said foam body; and
(iii) a fire-resistant interfacial layer disposed between said facer and first planar surface,
where said fire-resistant interfacial layer includes an intumescent material.

12. The construction board of claim 11, where said intumescent material is expandable graphite, and said expandable graphite is dispersed within a binder material.

13. The construction board of claim 11, where said fire-resistant interfacial layer includes from about 0.5 to about 50 wt. % expandable graphite relative to the entire weight of the layer.

14. The construction board of claim 11, where said facial includes an external coating layer disposed on a planar surface of said facer opposite said fire-resistant interfacial layer.
